(19) United States
(12) Patent Application Publication
(10) Pub. No.: US 2018/0153337 A1
(43) Pub. Date: Jun. 7, 2018

(54) METHOD FOR CONTROLLING BEVERAGE MACHINE

(71) Applicants: GUANGDONG MIDEA CONSUMER ELECTRICS MANUFACTURING CO., LTD., Foshan (CN); MIDEA GROUP CO., LTD., Foshan (CN)

(72) Inventors: Jian KUANG, Foshan (CN); Bingchao LIAO, Foshan (CN); Siyuan LI, Foshan (CN)

(21) Appl. No.: 15/578,233

(22) PCT Filed: May 30, 2016
(86) PCT No.: PCT/CN2016/083951

§ 371 Date: Nov. 29, 2017

(30) Foreign Application Priority Data
Mar. 21, 2016 (CN) 201610164150.5

(51) Int. Cl. A47J 31/56

(52) U.S. Cl. CPC A47J 31/56

(57) ABSTRACT

A method for controlling a drink machine (100), the drink machine (100) comprising a boiler (1), a brewing cavity (3), and a liquid pump (2) connected between the boiler (1) and the brewing cavity (3), the boiler (1) heating the liquid within the boiler (1) by means of a heating apparatus (12); the controlling method comprising the following steps: starting the heating apparatus (12) to heat the liquid within the boiler (1); detecting whether the liquid within the boiler (1) reaches a preset temperature; when the liquid within the boiler (1) reaches the preset temperature, the heating apparatus (12) stopping working and starting the liquid pump (2), after pausing for a first preset time; and starting the liquid pump (2) until the liquid within the boiler (1) is all transported to the brewing cavity (3), and continuing working for a second preset time.

### FIELD

The present invention relates to a technical field of beverage brewing, and more particularly to a method for controlling a beverage machine.

### BACKGROUND

In the related art, water temperature for beverage brewage in a beverage machine is not stable, and a method for controlling the beverage machine consumes great energy and has low reliability.

### SUMMARY

Embodiments of the present invention seek to solve at least one of the problems existing in the related art to at least some extent. For that reason, the present invention provides a method for controlling a beverage machine. This method can make full use of remaining heat in a boiler to keep water temperature stable, thus making a temperature of brewed coffee stable, so as to ensure the taste of coffee and save energy.

In the method according to according to embodiments of the present invention, the beverage machine includes: a boiler, a brewing cavity and a liquid pump connected between the boiler and the brewing cavity, the boiler being provided with a liquid level sensing device and a temperature sensor, and the boiler heating liquid therein by means of a heating device. The method includes the following steps: starting the heating device to heat the liquid in the boiler; detecting whether the liquid in the boiler reaches a preset temperature; stopping the heating device when the liquid in the boiler reaches the preset temperature, and starting the liquid pump after a first preset time t₁; pumping water to the brewing cavity through the liquid pump, and when a water level in the boiler reaches a water level detected by the liquid level sensing device, keeping the liquid pump working for a period of time t₂ until a brewing process is completed.

In the method according to according to embodiments of the present invention, after the liquid in the boiler reaches the preset temperature, the heating device is controlled to stop working, and the liquid pump is started after the first preset time t₁, such that the remaining heat in the heating device is fully utilized to keep the liquid (e.g. water) temperature stable and hence keep the temperature of the brewed beverage stable, thereby guaranteeing the taste of the beverage (e.g. coffee); additionally, the energy can be considerably saved to reduce the energy consumption of the beverage machine.

According to some embodiments of the present invention, the first preset time t₁ satisfies 5 s≤t₁≤10 s.

In one embodiment, the liquid level sensing device is a liquid level sensing rod configured to detect a minimum liquid level in the boiler.

Specifically, t₂ satisfies 20 s≤t₂≤30 s.

According to some embodiments of the present invention, working time of the heating device is t₃, and t₃ satisfies t₃≤120 s.

Further, before the heating device is started, the method further includes: detecting whether a liquid level in the boiler reaches a preset liquid level.

Specifically, the beverage machine includes a detachable brewing mechanism, and the brewing mechanism has the brewing cavity; and the method further includes: detecting whether the brewing mechanism is installed in place.

In one embodiment, the liquid level in the boiler is detected whether it reaches the preset liquid level after the brewing mechanism is detected whether it is installed in place.

Further, the beverage machine further includes a working status indicator lamp, and when the beverage machine is in an abnormal status, the working status indicator lamp flickers rapidly.

According to some embodiments of the present invention, the time required for the liquid pump to pump all the liquid in the boiler to the brewing cavity is t₄, and t₄ satisfies 35 s≤t₄≤60 s.

In one embodiment, the preset temperature is denoted as T, and T satisfies 80° C.≤T≤90° C.

According to some embodiments of the present invention, the beverage machine further includes a timer and a snap-action thermostat, the timer being provided to the beverage machine, and the snap-action thermostat being provided to the boiler; the method further includes: controlling the beverage machine to be powered off when the temperature sensor reaches the preset temperature T; or controlling the beverage machine to be powered off by means of the snap-action thermostat, when the temperature sensor fails, and the temperature of the boiler reaches a temperature point of the snap-action thermostat; or controlling the beverage machine to be powered off, when the temperature sensor and the snap-action thermostat both fail, and the timer starts counting from the time of heating and counts up to t₅.

In one embodiment, t₅ satisfies 120 s≤t₅≤180 s.

In one embodiment, the temperature sensor is a thermistor.

Specifically, the boiler is a non-sealed container.

Further, a boiler cover is provided on or above the boiler, and can be opened manually or automatically.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the drawings, in which:

FIG. 1 is a schematic view of a beverage machine according to embodiments of the present invention;

FIG. 2 is a control flow chart of a method for controlling a beverage machine according to embodiments of the present invention.

### REFERENCE NUMERALS

beverage machine 100;
boiler 1, liquid outlet 11, heating device 12, temperature sensor 13,
liquid pump 2, liquid inlet pipe 21, liquid outlet pipe 22,
brewing cavity 3.

### DETAILED DESCRIPTION

Reference will be made in detail to embodiments of the present invention. The same or similar elements and the elements having same or similar functions are denoted by like reference numerals throughout the descriptions. The embodiments described herein with reference to drawings are explanatory, illustrative, and used to generally understand the present invention. The embodiments shall not be construed to limit the present invention.

In the specification, it is to be understood that terms such as “central”, “lower”, “upper”, “front”, “rear”, “right”, “left”, “horizontal”, “vertical”, “top”, “bottom”, “inner”, “outer” and the like should be construed to refer to the orientation as then described or as shown in the drawings under discussion. These relative terms are for convenience of description and do not require that the present invention be constructed or operated in a particular orientation. Thus, these terms are not constructed to limit the present invention.

It should be noted that terms such as “first” and “second” are used herein for purposes of description and are not intended to indicate or imply relative importance or significance or to imply the number of indicated technical features. Thus, the feature defined with “first” and “second” may comprise one or more of this feature. Further, in the description of the present invention, “a plurality of” means two or more than two, unless specified otherwise.

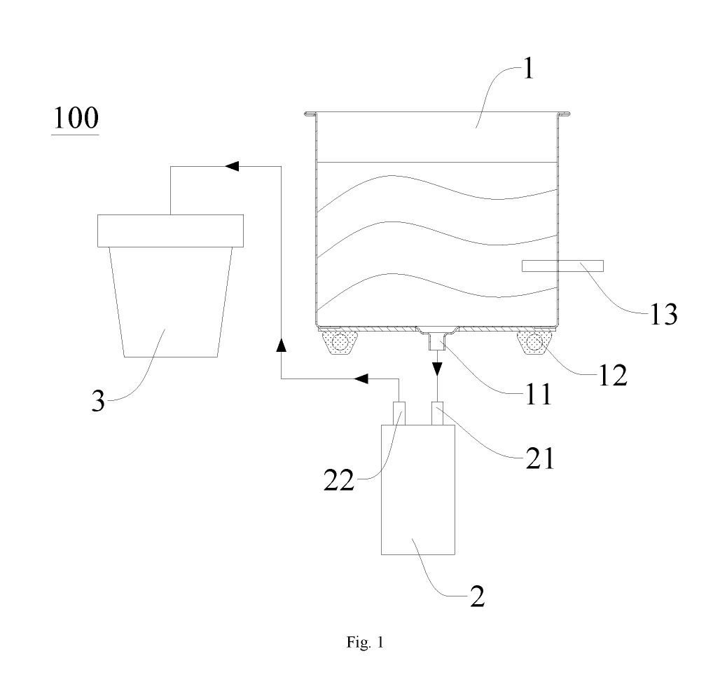

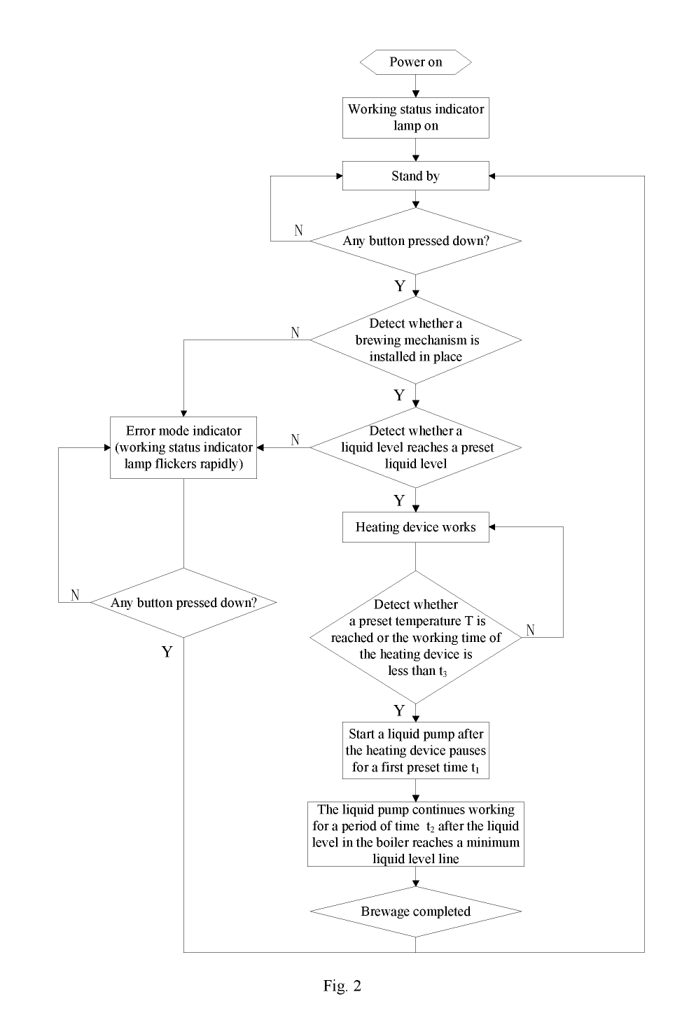

A method for controlling a beverage machine 100 according to embodiments of the present invention will be described below with reference to FIGS. 1-2. The beverage machine 100 can be a coffee machine. In the following description, the coffee machine is elaborated as an example of the beverage machine 100.

As shown in FIG. 1, in the method for controlling the beverage machine 100 according to embodiments of the present invention, the beverage machine 100, for example the coffee machine, includes a boiler 1, a brewing cavity 3, a liquid pump 2 connected between the boiler 1 and the brewing cavity 3. The boiler 1 is provided with a liquid level sensing device (not illustrated) and a temperature sensor 13. In one embodiment, the liquid level sensing device can be a liquid level sensing rod configured to detect a minimum liquid level in the boiler 1. Thus, it is convenient to monitor the liquid level condition in the boiler 1.

In one embodiment, the temperature sensor 13 can be but is not limited to a thermistor. Hence, it is possible to sense whether the liquid in the boiler 1 reaches a preset temperature by a sensing function of the temperature sensor 13, thereby improving the taste of a beverage and satisfying a user requirement for the quality of the beverage, and also it is possible to prevent overheating of the liquid in the boiler 1 and enhance the safety of the beverage machine 100.

The boiler 1 heats the liquid therein by means of a heating device 12. The liquid pump 2, for example a water pump can transport the liquid (like water) in the boiler 1 to the brewing cavity 3.

Specifically, referring to FIG. 1, a bottom of the boiler 1 is provided with a liquid outlet 11, and the liquid pump 2 is provided with a liquid inlet pipe 21 and a liquid outlet pipe 22. The liquid inlet pipe 21 is connected with the liquid outlet 11, and the liquid outlet pipe 22 is connected with the brewing cavity 3, such that the liquid pump 2 can transport the liquid in the boiler 1 to the brewing cavity 3 conveniently.

The boiler 1 may be a non-sealed container. For example, a top of the boiler 1 can be designed to be open, such that the boiler 1 is communicated with the outside atmosphere, thereby effectively reducing a safety hazard and improving safety and reliability of the beverage machine 100.

Further, a boiler cover (not illustrated) is provided on or above the boiler 1, in which the boiler cover can be opened manually or automatically, such that it is possible to o effectively prevent dust and the like from falling into the boiler 1 and prevent the liquid in the boiler 1 from splashing out.

Specifically, referring to FIG. 2, the method for controlling the beverage machine 100 includes the following steps: starting the heating device 12 to heat the liquid in the boiler 1; detecting whether the liquid in the boiler 1 reaches the preset temperature; stopping the heating device 12 when the liquid in the boiler 1 reaches the preset temperature, and starting the liquid pump 2 after the heating device 12 pauses for a first preset time t₁; pumping the water to the brewing cavity 3 by the liquid pump 2, and when the water level in the boiler 1 reaches a water level (e.g. the minimum liquid level line) detected by the liquid level sensing device, keeping the liquid pump 2 working for a period of time t₂ until a brewing process is completed. For example, during brewage of a beverage (like coffee), when the liquid level sensing device senses that the liquid level in the boiler 1 reaches the water level (e.g. the minimum liquid level line) detected by the liquid level sensing device, time counting to t₂ is started. Therefore, it can be ensured that when a different amount of liquid is added into the brewing cavity 3, the time of air extraction of the liquid pump 2 keeps consistent, thereby guaranteeing that residual liquid in the brewing cavity 3 can be blow-dried.

For example, during the beverage (e.g. coffee) brewage, the heating device 12, for example a heating tube, can be first started to heat the liquid (e.g. water) in the boiler 1. When the liquid in the boiler 1 reaches the preset temperature, the heating device 12 stops working, and after the first preset time t₁, the liquid pump 2 is started. In this case, during the first preset time t₁, remaining heat of the heating device 12 (e.g. the heating tube) can be used, i.e. make use of the remaining heat of the heating device 12 to heat the liquid in the boiler 1, so as to keep the temperature of the liquid (e.g. water) stable, thus making a temperature of the brewed beverage stable, and ensuring the taste of the beverage (like coffee); additionally, energy is greatly saved, and energy waste is avoided.

The liquid pump 2 draws and transports the water to the brewing cavity 3, and when the water level in the boiler 1 reaches the water level (e.g. the minimum liquid level line) detected by the liquid level sensing device, the liquid pump 2 continues working for a period of time t₂ until the brewing process is completed. Therefore, when the liquid pump 2 transports all the liquid in the boiler 1 to the brewing cavity 3 (i.e. the liquid in the boiler 1 is completely drained), air can be continuously transported to the brewing cavity 3 under the action of the liquid pump 2, so as to blow-dry the residual liquid in the brewing cavity 3, reducing difficulty of cleaning the brewing cavity 3, and residual beverage can be prevented from dripping around, which otherwise may contaminate the ambient environment, when the brewing cavity 3 is taken out.

In the method for controlling the beverage machine 100 according to embodiments of the present invention, after the liquid in the boiler 1 reaches the preset temperature, the heating device 12 is controlled to stop working, and the liquid pump 2 is started after the heating device 12 pauses for the first preset time, such that the remaining heat in the heating device 12 is fully utilized to keep the liquid (e.g. water) temperature stable and hence keep the temperature of the brewed beverage stable, thereby guaranteeing the taste of the beverage (e.g. coffee); additionally, the energy can be considerably saved to reduce the energy consumption of the beverage machine 100.

According to some embodiments of the present invention, the first preset time t₁ satisfies 5 s≤t₁≤10 s. The specific value of the first preset time t₁ can be determined based on practical requirements. For example, t₁ can further satisfy t₁=5 s (seconds). Thus, the remaining heat of the heating device 12 can be fully utilized, and the overall time for the beverage brewage can be shortened.

Specifically, t₂ satisfies 20 s≤t₂≤30 s. For example, t₂ can further satisfy t₂=30 s. Thus, it can ensure that the residual liquid in the brewing cavity 3 is blow-dried.

In one embodiment, the preset temperature is denoted as T, and T satisfies 80° C.≤T≤90° C. The specific value of T can be determined based on requirements of beverages.

According to some embodiments of the present invention, the working time of the heating device 12 is t₃, and t₃ satisfies t₃≤120 s. Thus, the liquid in the boiler 1 can be heated to the preset temperature, and the overall time for the beverage brewage can be shortened.

Further, the beverage machine 100 further includes a timer (not illustrated) and a snap-action thermostat (not illustrated). The timer is provided to the beverage machine 100, and the snap-action thermostat is provided to the boiler 1, for example on a bottom surface of the boiler 1.

According to some embodiments of the present invention, the method for controlling the beverage machine 100 further includes the following steps: controlling the beverage machine 100 to be powered off when the liquid in the boiler reaches the preset temperature T; or controlling the beverage machine 100 to be powered off by means of the snap-action thermostat, when the temperature sensor 13 (e.g. the thermistor) fails and the temperature of the boiler 1 reaches a temperature point of the snap-action thermostat; or controlling the beverage machine 100 to be powered off, when the temperature sensor 13 and the snap-action thermostat both fail and the timer starts counting from the time of heating and counts up to t₅. Therefore, the beverage machine 100 can be triply protected by the temperature sensor 13, the snap-action thermostat and the timer, thereby reducing the safety hazard and guaranteeing the operation safety of the beverage machine 100 considerably.

Specifically, t₅ satisfies 120 s≤t₅≤180 s. Thus, it is possible to prevent the boiler 1 from being heated for too long by the timekeeping of the timer, such that the overall time of the beverage brewage can be shortened. Additionally, the safety hazard can be further lowered and the safety of the beverage machine 100 can be enhanced.

Certainly, it could be understood that a fuse can be provided to the bottom surface of the boiler 1 to prevent overheating and play a role of protection.

According to some embodiments of the present invention, before the step of starting the heating device 12, the method also includes: detecting whether the liquid level in the boiler 1 reaches a preset liquid level. For example, the liquid level in the boiler 1 can be detected by the liquid level sensing device (like the liquid level sensing rod). Thus, it is convenient to monitor whether the liquid in the boiler 1 meets the requirements for brewing the beverage, thereby effectively improving the taste of the beverage.

Specifically, the beverage machine 100 can include a detachable brewing mechanism (not illustrated), and the brewing mechanism has the brewing cavity 3. Before the heating device 12 is started, the method further includes: detecting whether the brewing mechanism is installed in place. In one embodiment, detecting whether the liquid level in the boiler 1 reaches the preset liquid level after detecting whether the brewing mechanism is installed in place may occur.

Further, the beverage machine 100 further includes a working status indicator lamp (not illustrated), and when the beverage machine 100 is in an abnormal status, the working status indicator lamp flickers rapidly. It should be noted herein that “the abnormal status” in the present invention means the brewing mechanism is not in place or the liquid level in the boiler 1 does not reach the preset liquid level.

For example, when the liquid level in the boiler 1 does not reach the preset liquid level line, the working status indicator lamp can be set to flicker rapidly, for example regularly flicker rapidly at 200 ms (milliseconds), so as to remind the user to adjust the liquid level in the boiler 1. Hence, it is convenient to monitor whether the liquid in the boiler 1 meets the requirements for brewing the beverage, thereby effectively improving the taste of the beverage.

Moreover, the brewing mechanism can be provided with a safety switch. When the brewing mechanism is installed in place, the safety switch can be triggered, the brewing mechanism is powered on, and the beverage (e.g. coffee) brewage can be continued. When the brewing mechanism deviates from the correct position, an error message can be set, and for example, the working status indicator lamp can be set to regularly flicker rapidly at 200 ms (milliseconds), so as to remind the user to adjust the position of the brewing mechanism. Therefore, the beverage machine 100 can be prevented from working in the case where the brewing mechanism is deviated, so as to reduce the safety hazard effectively and further improve the safety and reliability of the beverage machine 100.

According to some embodiments of the present invention, the time required for the liquid pump 2 to pump the liquid in the boiler 1 to the brewing cavity 3 is t₄, and t₄ satisfies 35 s≤t₄≤60 s. Thus, not only the liquid amount requirement for the beverage brewage can be satisfied, but also the overall time for the beverage brewage can be shortened.

A specific embodiment of the method for controlling the beverage machine 100 according to the present invention will be described below with reference to FIG. 2

The method for controlling the beverage machine 100 according to the embodiment of the present invention includes the following steps: detecting whether the brewing mechanism is installed in place; detecting whether the liquid level in the boiler 1 reaches the preset liquid level; starting the heating device 12 to heat the liquid in the boiler 1; detecting whether the liquid in the boiler 1 reaches the preset temperature or the working time of the heating device 12 reaches 120 s; when the liquid in the boiler 1 reaches the preset temperature or the working time of the heating device 12 reaches 120 s, stopping the heating device 12, and starting the liquid pump 2 after 5 s; and when the liquid level in the boiler 1 reaches the minimum liquid level line, the liquid pump 2 continues working for 30 s.

For example, during the coffee brewage, the coffee machine is first connected to a power supply, and in such a case, the working status indicator lamp of the coffee machine is on, and the coffee machine enters a standby status.

Appropriate amount of water is added to the boiler 1, and a start switch of the beverage machine 100 is pressed; the brewing mechanism is detected whether it is in place; when the position of the brewing mechanism is wrong, the working status indicator lamp regularly flickers rapidly at 200 ms (milliseconds) to remind the user to adjust the position of the brewing mechanism, until the brewing mechanism is installed in place; the liquid level in the boiler 1 is detected whether it reaches the preset liquid level.

When the liquid level in the boiler 1 does not reach the preset liquid level line, the working status indicator lamp regularly flickers rapidly at 200 ms (milliseconds) to remind the user to adjust the liquid level in the boiler 1, until the liquid level in the boiler 1 reaches the preset liquid level, and then the heating tube is started to heat the water in the boiler 1.

When the water in the boiler 1 reaches 80° C., or the working time of the heating tube reaches 120 s, the heating tube stops working, and the liquid pump 2 is started after 5 s.

When the liquid level in the boiler 1 reaches the minimum liquid level, the liquid pump 2 continues working for 30 s.

With the method for controlling the beverage machine 100 according to embodiments of the present invention, the remaining heat of the heating device 12 is fully utilized, thereby saving energy considerably and reducing the energy consumption of the beverage machine 100. Additionally, the taste of the beverage is improved.

Reference throughout this specification to “an embodiment,” “some embodiments,” “an exemplary embodiment”, “an example,” “a specific example,” or “some examples,” means that a particular feature, structure, material, or characteristic described in connection with the embodiment or example is included in at least one embodiment or example of the present invention. Thus, the appearances of the above phrases in various places throughout this specification are not necessarily referring to the same embodiment or example of the present invention. Furthermore, the particular features, structures, materials, or characteristics may be combined in any suitable manner in one or more embodiments or examples.

Although explanatory embodiments have been shown and described, it would be appreciated by those skilled in the art that changes, modifications, alternatives and variants can be made in the embodiments without departing from principles and scope of the present invention. The scope of the present invention is defined by the claims and the like.

1. A method for controlling a beverage machine, characterized in that, the beverage machine comprises a boiler, a brewing cavity and a liquid pump connected between the boiler and the brewing cavity, the boiler being provided with a liquid level sensing device and a temperature sensor, and the boiler heating liquid therein by means of a heating device, and the method comprises steps:
starting the heating device to heat the liquid in the boiler;
detecting whether the liquid in the boiler reaches a preset temperature;
stopping the heating device when the liquid in the boiler reaches the preset temperature, and starting the liquid pump after a first preset time t1;
pumping water to the brewing cavity through the liquid pump, and when a water level in the boiler reaches a water level detected by the liquid level sensing device, keeping the liquid pump working for a period of time t2 until a brewing process is completed.

2. The method according to claim 1, characterized in that, the first preset time t1 satisfies 5 s≤t1≤10 s.

3. The method according to claim 1, characterized in that, the liquid level sensing device is a liquid level sensing rod configured to detect a minimum liquid level in the boiler.

4. The method according to claim 3, characterized in that, t2 satisfies 20 s≤t2≤30 s.

5. The method according to claim 1, characterized in that, working time of the heating device is t3, and t3 satisfies t3≤120 s.

6. The method according to claim 1, characterized in that, before starting the heating device, the method further comprises:
detecting whether a liquid level in the boiler reaches a preset liquid level.

7. The method according to claim 1, characterized in that, the beverage machine comprises a detachable brewing mechanism, and the brewing mechanism has the brewing cavity;
before the heating device is started, the method further comprises: detecting whether the brewing mechanism is installed in place.

8. The method according to claim 7, characterized in detecting whether a liquid level in the boiler reaches a preset liquid level after detecting whether the brewing mechanism is installed in place.

9. The method according to claim 6, characterized in that, the beverage machine further comprises a working status indicator lamp, and when the beverage machine is in an abnormal status, the working status indicator lamp flickers rapidly.

10. The method according to claim 1, characterized in that, the time required for the liquid pump to pump all the liquid in the boiler to the brewing cavity is t4, and t4 satisfies 35 s≤t4≤60 s.

11. The method according to claim 1, characterized in that, the preset temperature is denoted as T, and T satisfies 80° C.≤T≤90° C.

12. The method according to claim 11, characterized in that, the beverage machine further comprises a timer and a snap-action thermostat, the timer being provided to the beverage machine, and the snap-action thermostat being provided to the boiler; the method further comprises: controlling the beverage machine to be powered off when the temperature sensor reaches the preset temperature T; or controlling the beverage machine to be powered off by means of the snap-action thermostat, when the temperature sensor fails, and the temperature of the boiler reaches a temperature point of the snap-action thermostat; or controlling the beverage machine to be powered off, when the temperature sensor and the snap-action thermostat both fail, and the timer starts counting from the time of heating and counts up to t5.

13. The method according to claim 12, characterized in that, t5 satisfies 120 s≤t5≤180 s.

14. The method according to claim 12, characterized in that, the temperature sensor is a thermistor.

15. The method according to claim 1, characterized in that, the boiler is a non-sealed container.

16. The method according to claim 1, characterized in that, a boiler cover is provided on or above the boiler, and can be opened manually or automatically.
